(19) United States
(12) Patent Application Publication
(10) Pub. No.: US 2026/0008099 A1
(43) Pub. Date: Jan. 8, 2026

(54) Methods for Forming Parts by Spark Plasma Sintering and Additive Manufacturing

(71) Applicant: San Diego State University (SDSU) Foundation, DBA San Diego State University Research Foundation, San Diego, CA (US)

(72) Inventors: Eugene Olevsky, San Diego, CA (US); Maricruz Carillo, San Diego, CA (US); Elisa Torresani, San Diego, CA (US)

(73) Assignee: San Diego State University (SDSU) Foundation, DBA San Diego State University Research Foundation, San Diego, CA (US)

(21) Appl. No.: 18/993,431

(22) PCT Filed: Jul. 17, 2023
(86) PCT No.: PCT/US23/70347

§ 371 Date: Jan. 10, 2025

Related U.S. Application Data
(60) Provisional application No. 63/389,892, filed on Jul. 17, 2022.

(51) Int. Cl. B22F 3/105; B22F 3/10; B33Y 10/00; B33Y 80/00

(52) U.S. Cl. CPC B22F 3/105; B22F 3/1007; B22F 2003/1046; B22F 2003/1051; B22F 2201/10; B22F 2201/20; B33Y 10/00; B33Y 80/00

(57) ABSTRACT

Methods and apparatus for manufacturing a sintered powder manufactured item having an inhomogeneous internal and/or external geometry is provided. Processes and apparatus may comprise fabricating a sacrificial mold to be placed in a sintering die to create a sintering assembly, where the sintering assembly has a geometrically uniform external contour and defines an inner volume having at least one fillable space that is geometrically inhomogeneous. The part material is selected to have a lower sintering temperature than the at least one mold material such that when sintering the filled sintering assembly at a sintering temperature the at least one mold material remains un-sintered and at least one powder part material sinters to form a sinter manufactured item having a shape defined by the inner volume of the sintering assembly.

### CROSS-REFERENCE TO RELATED APPLICATIONS

The current application claims priority to Provisional Application No. 63/389,892, filed Jul. 17, 2022, the disclosure of which is incorporated herein by reference.

### GOVERNMENT SPONSORED RESEARCH

The invention was made with U.S. Government support under agreement number W911SR-14-02-0001 awarded by the Department of Defense, contract number W911-NF-20-2-0226 awarded by the Department of Defense, grant number 2119832 awarded by the National Science Foundation, and Contract No. DE-SC0008581 awarded by the Department of Energy. The U.S. Government has certain rights in the invention.

### FIELD OF THE INVENTION

This invention relates to spark plasma sintering methods; and more particularly, to spark plasma sintering methods for manufacturing high temperature resistant components with complex internal and/or external interfaces and parts made thereby.

### BACKGROUND OF THE INVENTION

Spark plasma sintering (SPS), or electric current assisted sintering, is a materials processing technology which involves the simultaneous application of pressure and electrical field to consolidate powder materials. Densified components are formed through the consolidation of powdered materials from the application of heat and pressure. The application of the electric current increases the rate of heating to allow SPS to be used to fabricate high temperature resistant material components. Additive manufacturing (AM) is a materials processing technology which involves depositing a material in layers that bind through binders. AM is capable of producing complex shapes but is unable to fabricate using materials that are high temperature resistant.

### SUMMARY OF THE INVENTION

Many embodiments are directed systems and methods of fabricating sinter powder manufactured items with complex bodies.

An embodiment of the invention includes a process for producing a sintered powder manufactured item, including: providing a sintering die defining a die volume; providing at least one sacrificial mold body formed of at least one mold material; disposing the at least one sacrificial mold body in the at least one sintering die to form a sintering assembly having a geometrically uniform external contour defined by the sintering die volume and an inner volume having at least one geometrically inhomogeneous fillable space defined by the at least one sacrificial mold body; loading the inner volume with at least one part material to form a filled sintering assembly that is geometrically homogeneous, wherein the at least one part material has a lower sintering temperature than the at least one mold material; sintering the filled sintering assembly at a sintering temperature, such that the at least one mold material remains un-sintered and the at least one part material sinters to form a sintered manufactured item having a shape defined by the inner volume of the sintering assembly.

In an additional embodiment, the process further includes a step for removing the at least one mold material from the sintered manufactured item.

In a further embodiment, the step removing the at least one mold material includes a process selected from the group consisting of scraping, using compressed air, sand blasting, annealing, and any combination thereof.

In another embodiment, the at least one sacrificial mold comprises an additive manufacturing process.

In another further embodiment, the additive manufacturing process is selected from the group consisting of binder jetting, solvent jetting, 3D printing, stereolithography, and any combination thereof.

In an additional embodiment, the at least one mold material includes at least one binder and at least one material selected from a group consisting of metal powder, a metal alloy powder, a ceramic powder, a polymer powder, a clay powder, a graphite powder, and any combination thereof.

In another embodiment, the at least one sacrificial mold further includes heating the at least one sacrificial mold such that the at least one mold material undergoes partial debinding.

In yet another embodiment, the at least one part material includes at least material selected from the group consisting of a metal powder, a metal alloy powder, a ceramic powder, a polymer powder, a stainless steel powder, a Titanium alloy powder, a Nickel alloy powder, a Chromium alloy powder, an Aluminum alloy powder, and any combination thereof.

In a further yet embodiment, the at least one sacrificial mold further includes coating an external surface of the at least one sacrificial mold with a coating material, such that the coating material acts as an insulator.

In another additional embodiment, the coating material is alumina.

In a yet further embodiment, for stacking a plurality of sacrificial molds of claim 2 further comprising interleaving a separator between each sacrificial mold, such that cross-linking between a plurality of sinter powder manufactured items is reduced.

In a further embodiment, the process further includes selecting the at least one part and at least one mold materials using a sintering model embedding an FEM software.

In a yet further embodiment, includes selecting the at least one part and at least one mold materials using a sintering model embedded in an FEM software based on a continuum theory of sintering including:
a sintering data for the part and the mold material;
inputting the sintering data into the sintering model to determine a porosity function for each material;
determining a power creep factor and a power creep activation energy based on the sintering data for each material using a strain rate sensitivity exponent that is fixed;
defining an equivalent strain rate, a normalized shear, a bulk viscosity, and a sintering stress as the porosity function for each material; and
determining at least one parameter selected from the group of
   a normalized shear and a bulk viscosity using the sintering data for each of the part and mold material,
   a sintering stress based on at least one of a surface energy, a powder particle radius, and the sintering data of each of the part and mold material, a shape change rate based on the sintering data for each of the part and mold material,
   an equivalent strain rate based on at least one of the bulk viscosity, the sintering stress, the shape change rate, and the sintering data of each of the part and mold material, and
   a constitutive relationship of each of the part and mold material based on the equivalent stress, the equivalent strain rate, the normalized sheer, the bulk viscosity, the sintering stress, and a Kroenecker delta.

In a still yet further embodiment, the model further includes linearizing the constitutive relationship of each of the part and mold material for SPS using a natural log function.

In another embodiment, the sintering includes spark plasma sintering.

In a further embodiment, the sintering is conducted in a vacuum.

In another additional embodiment, the sintering is conducted in an atmosphere of an inert gas selected from the group consisting of Nitrogen, Argon, and Helium.

In a yet another embodiment, the sintering is conducted at a pressure of from about 1 to 10 Torr.

In a further yet embodiment, the sintering is conducted at a temperature of from about 1000° C. to 1900° C.

In another further embodiment, the sintering is conducted at a temperature of from about 500° C. to 1200° C.

In an additional embodiment, the process further includes cleaning the sinter powder manufactured item.

In yet an additional embodiment, the cleaning is selected from a process selected from the group of compressed air, polishing, annealing, and any combination thereof.

In yet another embodiment, the at least one sacrificial mold defines an internal structure of the sinter powder manufactured item selected from the group consisting of an internal cavity, a channel, an internal 3D structure, and any combination thereof.

In a further embodiment, the at least one sacrificial mold defines a geometrically irregular external surface of the sinter powder manufactured item.

In another embodiment, the at least one sacrificial mold defines an internal structure of the sinter powder manufactured item selected from the group consisting of an internal cavity, a channel, an internal 3D structure, and any combination thereof, and a geometrically irregular external surface of the sinter powder manufactured item.

In yet another embodiment, the process further includes: forming a plurality of sintering assemblies; stacking the plurality of filled sintering assemblies to form a stack of filled sintering assemblies that is geometrically homogeneous; and sintering the stack of filled sintering assemblies to simultaneously form a plurality of sintered manufactured items.

In yet a further embodiment, the process further includes interleaving a separator layer between each of the plurality of sintering assemblies, such that cross-linking between a plurality of sinter powder manufactured items is reduced.

In an additional embodiment, the separator layer is formed of graphite foil.

In another further embodiment, each of the sintering assemblies further includes an alignment element selected from the group consisting of a registration line, registration tab, a registration bead and dimple, and any combination thereof.

An apparatus for producing a sintered powder manufactured item, including:
a sintering chamber configured to apply a sintering pressure and a sintering temperature;
a sintering die defining a die volume disposed within the sintering chamber;
at least one sacrificial mold body formed of at least one mold material, and configured to be disposed in the at least one sintering die to form a sintering assembly having a geometrically uniform external contour defined by the sintering die volume and an inner volume having at least one geometrically inhomogeneous fillable space defined by the at least one sacrificial mold body;
wherein the inner volume is configures to be loaded with at least one part material such that a filled sintering assembly may be formed that is geometrically homogeneous, wherein the at least one part material has a lower sintering temperature than the at least one mold material; and
wherein the sintering chamber is configured to sinter the filled sintering assembly at a sintering temperature, such that the at least one mold material remains un-sintered and the at least one part material sinters to form a sintered manufactured item having a shape defined by the inner volume of the sintering assembly.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 illustrates a process diagram in accordance with embodiments.

FIGS. 2A and 2B illustrate process diagrams in accordance with embodiments.

FIGS. 3A and 3B provides a data chart showing sintering conditions whereby the part material achieves a higher density at a lower temperature and pressure than the mold material in accordance with embodiments.

FIG. 4 illustrates a diagram of a process for fabricating a sinter powder manufactured item with four channels in accordance with an embodiment.

FIG. 5A illustrates the temperature and pressure conditions for sintering a four-channel HAP sinter powder manufactured item in accordance with an embodiment.

FIG. 5B illustrates the temperature and pressure conditions for sintering a stainless steel sinter powder manufactured item with an internal channel in accordance with an embodiment.

FIGS. 6A through 6C illustrate a dental crown with a complex external surface fabricated via a process in accordance with an embodiment.

FIGS. 7A and 7B illustrate process diagrams for fabricating a plurality of sinter powder manufactured items in accordance with embodiments.

FIG. 8 illustrates a process diagram for modelling a sinter powder manufactured component in accordance with embodiments.

FIGS. 9A through 9C illustrate the relative density of HAP, Alumina, and stainless steel as temperature increased during sintering in accordance with an embodiment.

FIG. 9D illustrates the relative density for graphite during cold compaction in accordance with an embodiment.

FIGS. 10A through 10C illustrate FEM model results of the four-channel HAP sinter powder manufactured item in accordance with an embodiment.

FIGS. 11A through 11F illustrate SEM images of raw powders.

FIGS. 12A through 12D illustrate a process for fabricating a sinter powder manufactured item with complex external geometries in accordance with an embodiment.

FIGS. 13A through 13C illustrate a HAP sinter powder manufactured item with four channels and its grain size in accordance with an embodiment.

FIGS. 13D through 13F illustrate a HAP sinter powder manufactured item with no channels and its grain size in accordance with an embodiment.

FIG. 14 illustrates an X-Ray Diffraction of a HAP sinter powder manufactured item in accordance with an embodiment.

FIGS. 15A through 15C illustrate a process for fabricating a stainless steel sinter powder manufactured item with an internal channel in accordance with an embodiment.

FIG. 16 illustrates micrographs of a stainless steel sinter powder manufactured item in different areas in accordance with an embodiment.

FIGS. 17A through 17C illustrate FEM model results of the stainless steel sinter powder manufactured item in accordance with an embodiment.

FIG. 18 illustrates the waisting affect during sintering of straight walls during sintering in accordance with an embodiment.

### DETAILED DISCLOSURE OF THE INVENTION

Turning now to the drawings, a method of manufacturing high temperature resistant components with complex internal and/or external bodies in accordance with various embodiments are illustrated. In some embodiments, a process for producing a sintered powder manufactured item having an inhomogeneous internal and/or external geometry is provided. In various embodiments such processes may comprise fabricating a sacrificial mold to be placed in a sintering die to create a sintering assembly, where the sintering assembly has a geometrically uniform external contour and defines an inner volume having at least one fillable space that is geometrically inhomogeneous. In various embodiments, the sacrificial mold may be made using at least one mold material different from the material used to make the part. In some embodiments the at least one part material is loaded into the fillable space of the sintering assembly, such that the filled sintering assembly is geometrically homogenous. In embodiments, the at least one part material is selected to have a lower sintering temperature than the at least one mold material such that when sintering the filled sintering assembly at a sintering temperature the at least one mold material remains un-sintered and at least one powder part material sinters to form a sinter manufactured item having a shape defined by the inner volume of the sintering assembly. Various embodiments may also incorporate methods for removing the mold material from the sinter manufactured item and post processing the manufactured item.

Embodiments may also be directed to a batch process for producing a plurality of sintered powder manufactured items having an inhomogeneous internal and/or external geometry. Such embodiments may comprise fabricating a plurality of stackable sacrificial molds, to be stacked in a sintering die to create a sintering assembly having a geometrically uniform external contour and defining an inner volume having at least one fillable space that is geometrically inhomogeneous. In various such embodiments the plurality of stackable sacrificial molds may be made from at least one mold material such that the at least one part material may be loaded into the fillable space of the sintering assembly, such that the filled sintering assembly is geometrically homogenous. In embodiments, the at least one part material has a lower sintering temperature than the at least one mold material such that after sintering the plurality of sinter manufacture final products may be removed from the un-sintered mold material. In many embodiments, the sintering assembly of stacked sacrificial molds may include interleaving a graphite foil sheet between each sacrificial mold to prevent cross-linking the sinter manufactured items.

In many embodiments SPS and 3D printing may be used to manufacture complex shapes comprising metallic and ceramic parts. In several embodiments, a process for producing near net shape ceramic and metallic parts is able to design and produce custom complex shapes. In many embodiments, a Solvent Jetting process may be used to print the sacrificial mold. In some embodiments, a SPS process may be used to consolidate the component material.

Advanced sintering techniques such as electric field assisted sintering, also known as “spark plasma sintering”, involve high pressures (up to about 100 MPa) and very high temperatures (up to about 2000° C.), and enable the consolidation of nearly all of the component powders from which objects are made, including polymers, metals and ultra-high temperature materials (such as silicon carbide) and provide the ability to control the microstructure of an object. These techniques are very useful for the fabrication of high-performance materials, but it is often impossible to generate complex shapes using such methods.

Despite the SPS technology's potential to produce components with high mechanical properties and tailored microstructures, it is typically limited to the production of components with simple shapes, such as cylinders. This limitation primarily derives from the inhomogeneity that is usually introduced by the application of pressure to components with complex shapes that have a different thickness in the direction of pressing. In uniaxial compaction, the thinner areas densify earlier and typically prevent the punches from completely densifying the entire component. In addition, nonuniformity of temperature and electric current density can also contribute to structure heterogeneities in complex-shape components manufactured using SPS. Different approaches to overcome this limitation have been proposed. These methods typically focus on the net-shaping of the external geometry of the components. However, in many applications the fabricated components also may need to have internal features such as channels or holes.

For example, for applications in the energy sector there is great interest in manufacturing ultra-high-temperature resistant components, such as turbine blades, to enhance the efficiency of power generation. However, the production of components using ultra-high-temperature resistant materials is very costly and difficult via both traditional manufacturing and AM technologies. Typically, these components integrate design features, such as cooling channels and holes, to increase efficiency and enable them to be manufactured from less expensive alloys with lower working temperatures. These features are conventionally produced through laser machining in traditionally manufactured components or are a part of the original design in the components produced AM. Both processes have a few disadvantages. Laser machining is costly and difficult to operate for fragile/brittle materials. Similarly, AM (e.g. selective laser melting (SLM)/selective laser sintering (SLS)), while allowing the production of components with complex shapes, is time consuming and also requires a post-processing step to remove the thermal stresses and/or refine the microstructure.

Internal channels are also important for ceramic components involved in various energy applications such as solar cells, wind rotors, heat transfer devices, and regenerative cooling systems for hypersonic vehicles. When considering manufacturing of channels, a concern is removing material from inside the designed openings. Typically, in energy applications, ceramic components with channels are made by slip casting or injection molding in two pieces that are then joined, which can create locations for potential early failures. Through-hole channels can also be machined into the parts but typically add to the cost and processing steps. Self-supported 3D printing techniques, such as binder jetting and stereolithography (SLA), are being considered for parts that require internal channels. Binder jetting has been successful to produce a prototype of a one-piece concentrating solar power ceramic heat exchanger, highlighting the advantage of AM by producing a complex internal structure in one print. However, high density was not achieved despite the long debinding and sintering cycles used.

In the biomedical industry, ceramics requiring internal cavities are being used mostly for orthopedic applications such as bone tissue engineering, bone implants and scaffolds. Some traditional methods for producing porous implants include salt leaching, freeze drying, gel or chemical forming. These techniques typically have limited ability to include or tailor external and/or internal geometries. Internal architecture is important in mimicking bone because these channels allow nutrient absorption and cell adhesion. AM becomes particularly attractive for orthopedics due to the ability to tailor the geometry of scaffolds and implants to the patient specific injury; however, high temperature resistant components with internal structures and channels are difficult to produce with AM. High density ceramic components with complex external geometries can be designed and produced using printed molds and applying pressure before free sintering. Ceramics are typically used to produce a high-density bio-ceramic but can be difficult to work with due to their high melting temperatures, yet low phase transition temperatures. To retain the biocompatibility of Hydroxyapatite (HAP) for example, must sinter at temperatures below approximately 1300° C.

Overall, conventional sintering is the most common method for producing ceramics. In AM, SLA has been the most common 3D printing method explored for ceramic components with internal channels and cavities. However, there are issues with both traditional and additive manufacturing methods that include the inability to completely remove the polymer binder and long debinding times which, limit the applicability of advanced ceramics in industry. Moreover, as previously discussed, in sintering temperature distribution throughout the SPS die determines the rate of densification. The application of pressure to components with complex shapes that have different thicknesses in the direction of pressing can result in structural inhomogeneity. In uniaxial compaction, the thinner areas densify earlier and prevent the punches from completely densifying the entire component. Nonuniformity of temperature and electric current density can also contribute to structure heterogeneities in complex shape components manufactured using SPS.

A process, in accordance with many embodiments, of producing ceramic and/or metallic parts with complex internal and/or external features using a combination of AM and SPS is provided. Complex features in accordance with many embodiments may be understood to include external or internal elements of the part that are geometrically inhomogeneous (e.g., would create structural inhomogeneities using a conventional SPS methods because of nonuniform densification, such as, for example, might be caused by the introduction of non-geometrically symmetric features), and are therefore inaccessible via such traditional SPS methods. Various embodiments provide processes capable of forming parts with such complex features, such as, for example internal channels, internal 3D structures, internal cavities, and/or external interfaces.

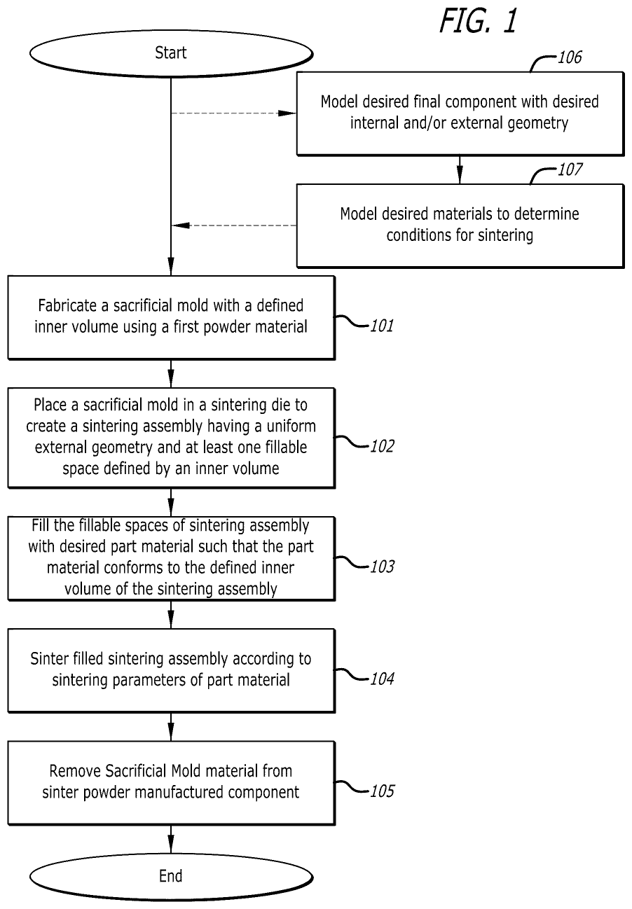

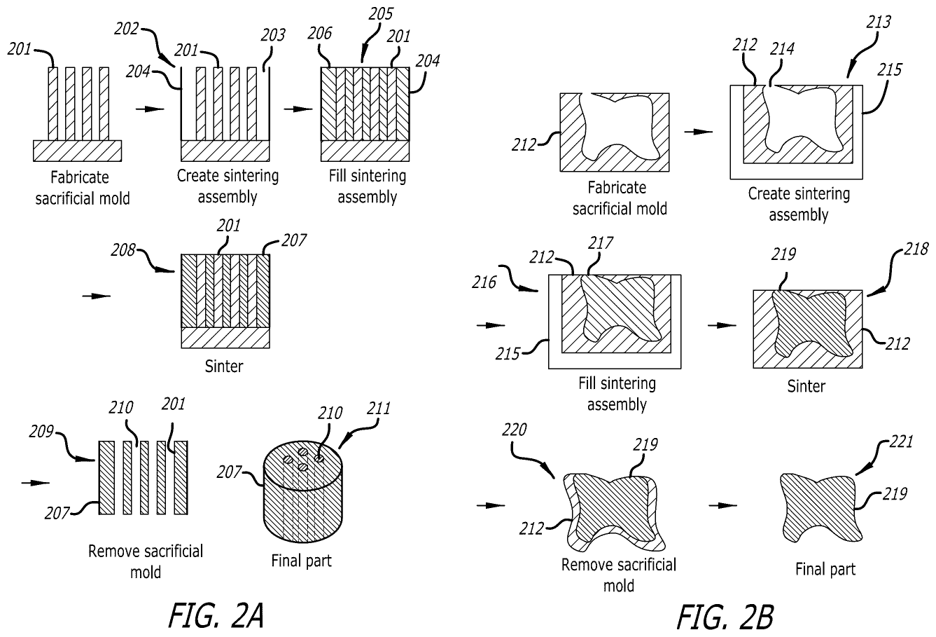

FIG. 1 provides an exemplary process flowchart in accordance with some embodiments, whereby a sintering assembly may be created to serve as a mold, or shaper, for one or more subsequent part materials to be inserted and then sintered into a final part. As shown in the flowchart, a sacrificial mold is provided or fabricated 101 and configured to be placed in a sintering die to form a sintering assembly 102 (see, e.g., elements 201 & 212 of FIGS. 2A & 2B, below). In embodiments of the exemplary process, the sintering assembly thus formed 102 (see, e.g., elements 202 & 213 of FIGS. 2A & 2B, below) has a geometrically symmetric external contour and that defines an internal volume having one or more fillable spaces (see, e.g., elements 203 & 214 of FIGS. 2A & 2B, below). The fillable spaces of the sintering assembly in various embodiments are defined by an internal surface of one of the outer walls of the sintering assembly and/or an internal sacrificial mold wall that subdivides the internal volume (see, e.g., element 203 of FIG. 2A, below). In various embodiments the sacrificial mold may either or also define the external boundaries of the final part (see, e.g., element 213 of FIG. 2B, below). In several embodiments the sintering die may define the external boundaries of the final part (see, e.g., element 202 of FIG. 2A, below), and/or the internal boundaries of the final part may be defined by the configuration of the inner volume of the sintering assembly (see, e.g., elements 203 & 214 of FIGS. 2A & 2B, below). The inner volume of the sintering assembly may be subdivided into internal volumes by the fillable spaces of the sacrificial mold (see, e.g., elements 203 & 214 of FIGS. 2A & 2B, below). In such embodiments, these sintering assembly and sacrificial mold walls taken together define one or more external or internal features of the final part having complex boundaries that would create structural inhomogeneities within a part under conventional SPS conditions. (e.g., non-geometrically symmetric features). In several embodiments the sacrificial mold may be provided or fabricated via an AM process suitable for depositing materials compatible with SPS, which may include but is not limited to binder jetting, stereolithography, solvent jetting, 3D printing, material jetting, fused deposition modelling, electron beam melting, sheet lamination, power bed fusion, and any combination thereof.

Regardless of the manner in which the sacrificial mold is manufactured, it may be formed from a mold material compatible with the AM process chosen and capable of forming a sacrificial mold suitable for use with SPS, such that the mold material sinters at a higher temperature/pressure than the desired part material. In accordance with such embodiments, mold materials may include (but are not limited to), for example, a metal powder, a metal alloy powder, a ceramic powder, a polymer powder, a graphite powder, a clay powder, and any combination thereof. In such embodiments, the mold material may contain binders to aid in the fabrication of a sacrificial mold during the additive manufacturing process in accordance with certain embodiments. After the sacrificial mold has been fabricated, the mold may be further processed in accordance with some embodiments, such as, for example, heat treated at an elevated temperature to remove impurity or binder. In some embodiments such processes include (but are not limited to) heating a sacrificial mold so it may be subject to partial debinding, such that post-sintering release of a desired, densified component is easier.

In several embodiments, the part material may then be disposed inside the fillable spaces of the sacrificial mold in raw form 103 (see, e.g., exemplary elements 205 & 216 of FIGS. 2A & 2B, below). In many such embodiments the part material is in a powder form such that it when disposed within the fillable spaces it fully conforms to all of the internal contours of the fillable spaces within the internal volume of the sacrificial mold (see, e.g., exemplary elements 206 & 217 of FIGS. 2A & 2B, below). In various embodiments, the part material is a raw powder material, e.g., with no binder or preparation before it is placed in a SPS machine. Although the above discussion has described the part material in the singular, it should be understood that the part material may be a single material or a suitable combination of materials. Where multiple materials are used, these materials may be disposed in separate fillable volumes or intermixed as appropriate for the final part. In several embodiments, the part material may comprise one or more of the following: a metal powder, a metal alloy powder, a ceramic powder, a polymer powder, a stainless steel powder, a Titanium alloy powder, a Nickel alloy powder, a Chromium alloy powder, an Aluminum alloy powder, and any combination thereof.

Regardless of the specific material types chosen, the mold material is different than the part material, such that the materials sinter at different temperatures. The mold material sinters at a temperature higher than the part material such that the part material forms a solid part while the mold material remains uncured and easy to remove via conventional mechanical techniques. In many embodiments the mold powder material may be clay or ceramic that sinters at a first temperature between about 1000° C. to about 1400° C.; or between about 1200° C. to about 1600° C.; or between about 1400° C. to about 1800° C.; or between about 1500° C. to about 1900° C. In several embodiments the part material may be a powdered metal or a powdered metal-alloy that sinters at a second temperature between about 500° C. to about 1000° C.; between about 700° C. to about 1100° C.; between about 900° C. to about 1200° C. Regardless of the specific sintering temperatures of the materials, it will be understood that in many embodiments a filled sacrificial mold is sintered according to sintering parameters for the part material rather than the mold material.

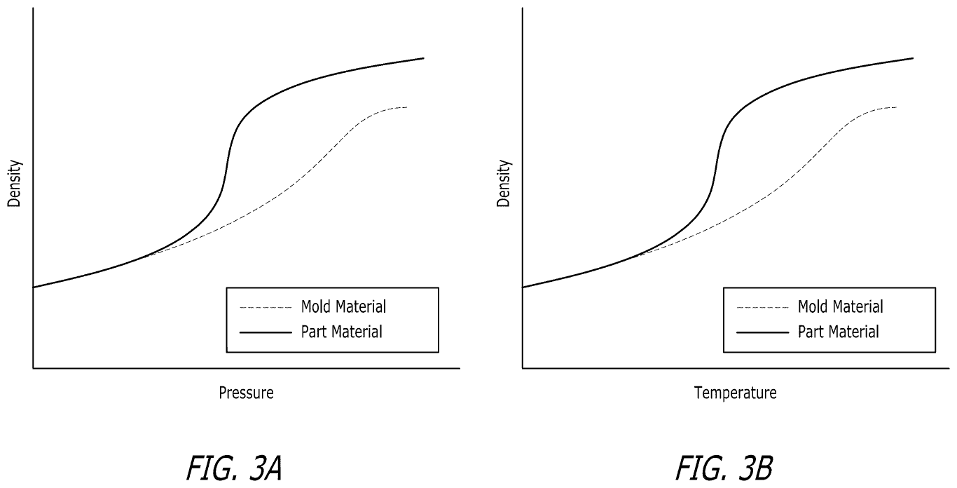

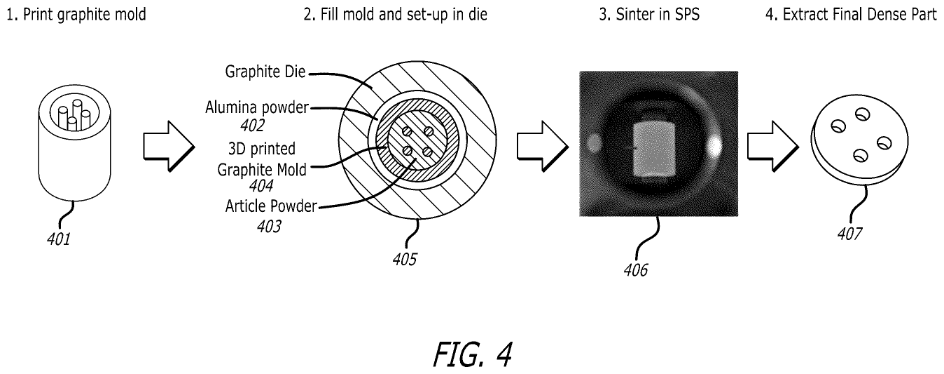

Once the part material(s) is disposed within the sacrificial mold, the filled sacrificial mold is sintered 104 (see, e.g., elements 208 & 218 of FIGS. 2A & 2B, below) such that the part material sinters (see, e.g., elements 207 & 219 of FIGS. 2A & 2B, below) while a mold material remains un-sintered (see, e.g., elements 201 & 212 of FIGS. 2A & 2B, below). In many embodiments such processes include (but are not limited to) spark plasma sintering. In most embodiments a sintering process is performed at a pressure and temperature to densify the part material. In many embodiments such processes include (but are not limited to) sintering in a vacuum or oxygen/hydrogen free atmosphere. In several embodiments, such processes include (but are not limited to) sintering by vacuum heating at a pressure of about 1-10 Torr, wherein the sintering temperature of the part material is between 500° C. to 1000° C. In some embodiments, such processes include (but are not limited to) sintering in an atmosphere of inert gas selected from the group consisting of Nitrogen, Argon, and Helium. FIGS. 3A and 3B demonstrate graphs showing how, by proper selection of materials, the part material consolidates at a lower temperature and pressure than the mold material. In many embodiments, such processes sinter according to the parameters for the part material, the part material sinters while the mold material remains un-sintered. Thus by selecting the mold and part materials in accordance with embodiments it is possible to produce fully sintered parts while leaving the mold un-sintered. For example, FIGS. 4A and 4B demonstrate the sintering parameters for part materials in accordance with certain exemplary embodiments. FIG. 4A demonstrates the sintering temperature of a sinter powder manufactured item with 4 channels formed from HAP needs to be heated such that the overall sinter assembly does not exceed 1600° C. In contrast, FIG. 4B illustrates the sintering temperature of a sinter powder manufactured stainless steel item with a channel needs to be configured such that the overall temperature of the sinter assembly does not exceed 1000° C.

In various embodiments, after sintering, the sacrificial mold is then removed from a sinter powdered manufactured item 105 (see, e.g., elements 209 & 220 of FIGS. 2A & 2B, below). In many embodiments the mold material is typically not fully sintered. In several embodiments the mold material (see, e.g., elements 201 & 212 of FIGS. 2A & 2B, below) is removed from the final sinter part (see, e.g., elements 207 & 219 of FIGS. 2A & 2B, below). In various embodiments, suitable mechanical processes may be used such processes include (but are not limited to) scraping off a mold material, brushing off a mold material using compressed air to remove a mold material, using tweezers to remove a mold material, sand blasting a mold material, annealing a mold material, and any combination thereof. In several embodiments, such processes include (but not limited to) cleaning the sinter powder manufactured item using compressed air, annealing, polishing, and any combination thereof. In several embodiments, using a graphite sacrificial mold, the sacrificial mold is removed from the internal channels and cavities via sand blasting and/or annealing.

As discussed, components manufactured in accordance with several embodiments comprise a complex shape with a channel, an internal cavity, internal 3D structure, and/or external geometry. Geometric customization of the additive manufactured sacrificial mold and a reduced debinding process, in accordance with some embodiments, can create a component with a complex shape with a channel, an internal cavity, internal 3D structure, and/or external geometry. Reduced sintering, in accordance with certain embodiments, can enable higher density with limited grain growth.

Using processes according to many embodiments, the internal geometry may comprise an internal cavity, a channel, an internal 3D structure, or any combination thereof. FIG. 2A demonstrates a process for producing a sinter powder manufactured item with internal channels in accordance with an embodiment. As shown a sacrificial mold 201 is fabricated from at least one mold material. In such embodiments, the sacrificial mold 201 is placed in a sintering die 204 to create a sintering assembly 202, defining an inner volume with at least one fillable space 203 forming one or more internal channels. According to embodiments of the process, the fillable spaces 203 of the sintering assembly are then loaded with a part material 206 such that the part material conforms to the defined inner volume 205 such that the internal walls of the sintering die 204 define the external boundary of the part material and the sacrificial mold 201 subdivides the internal fillable spaces 203, and such that the overall sintering assembly 202 is geometrically homogeneous. The filled sintering assembly is then sintered 208 according to the sintering parameters of the part material, in accordance with embodiments, such that the part material sinters 207 and the sacrificial mold remains un-sintered 201. In various embodiments, the sinter manufactured part is then removed from the sintering die 209 and the mold material 201 is removed from the sinter manufactured part 207. The final sinter manufactured part 211 with internal channels 210 may further be cleaned to remove any residual mold material 211.

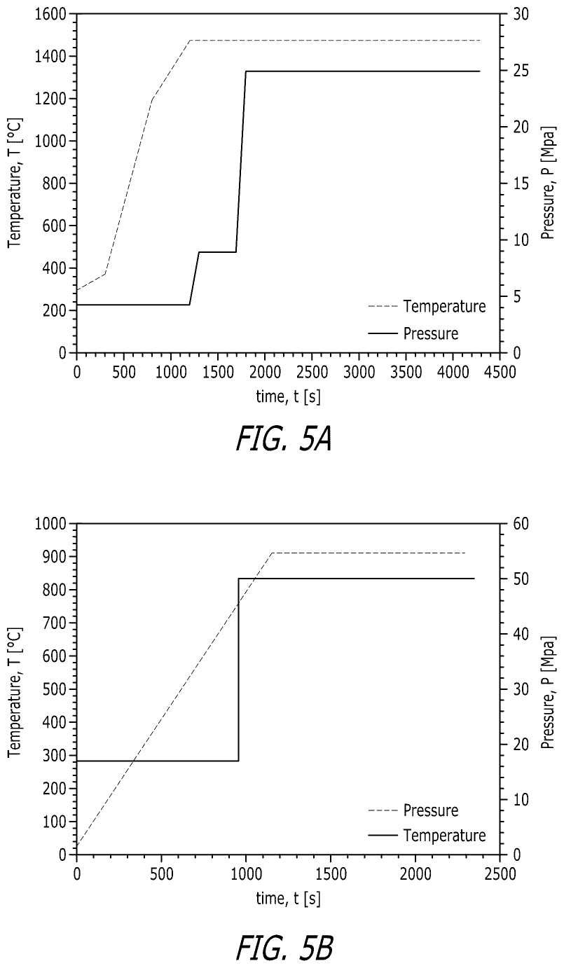

FIG. 5 demonstrates an exemplary process for producing a sinter powder manufactured item with internal channels 507 in accordance with the above described embodiment using graphite for the sacrificial mold 504 and HAP as the part material 503. In accordance with an embodiment, the sacrificial mold 501 may be coated in an insulating powder, such as Alumina 502.

In many embodiments the sacrificial mold can alternatively define the external boundaries of a final part. FIG. 2B illustrates a process for producing a sinter powder manufactured item with an inhomogeneous external geometry in accordance with an embodiment. In such embodiments the sacrificial mold 212 is provided or fabricated from a mold material and placed in a sintering die 215 to create a sintering assembly 213 that defines a fillable inner volume 214. The fillable space 214 of a sintering assembly may then be loaded with a part material 217 such that the part material conforms to the defined inner volume 214 such that the sacrificial mold forms the external boundary of the material powder and the overall homogeneous sintering assembly 216. The filled sintering assembly 216 is then sintered 218 according to the sintering parameters of the part material, in accordance with embodiments, such that the part material sinters 219 and the mold material remains un-sintered 212. In various embodiments, the sinter manufactured part may then be removed from the sintering die 220 and the mold material 212 removed from the sinter manufactured part 219. The final sinter manufactured part 219 may be further cleaned to remove any residual mold material 221 in various embodiments.

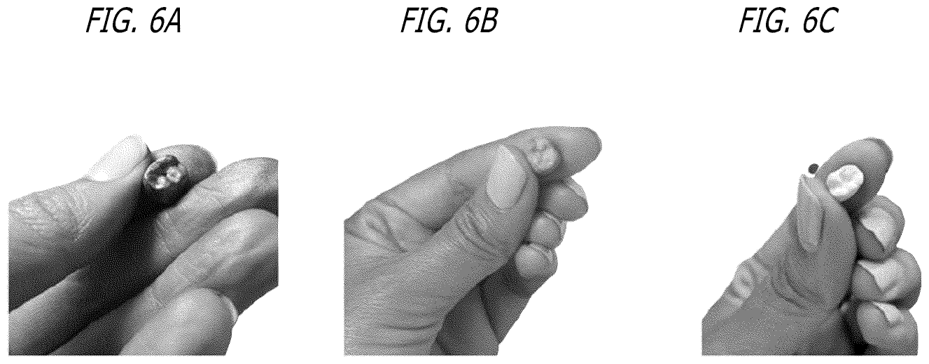

FIGS. 6A through 6C illustrate a dental crown final component from HAP powder with an inhomogeneous external geometry according to the above exemplary embodiments. FIG. 6A illustrates a dental crown final component covered in its graphite mold. FIG. 6B illustrates the initial removal of the graphite mold with a brush. Most of the graphite is removed with a brush but the final cleaning is done via temperature annealing. FIG. 6C illustrates the final densified dental crown after cleaning.

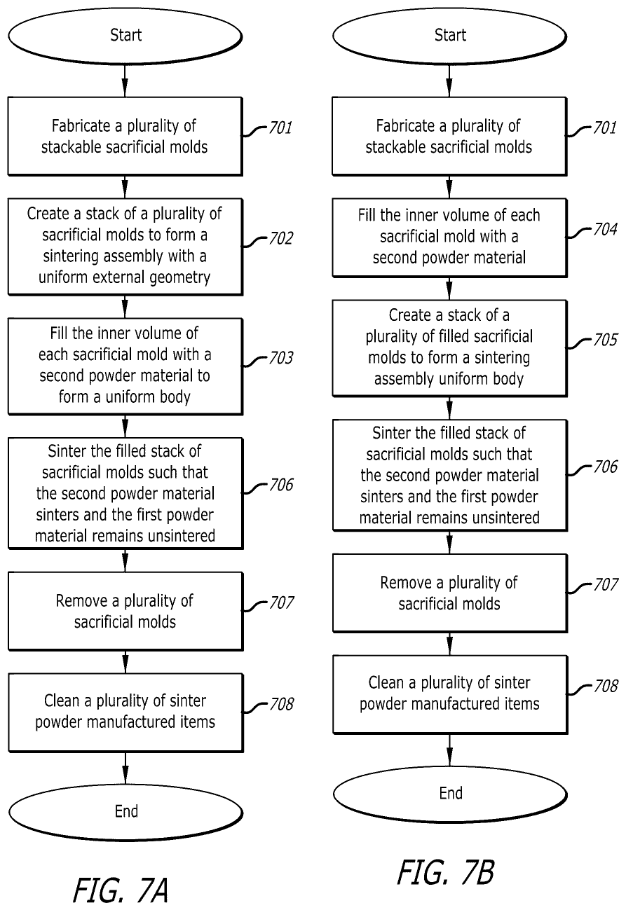

Although the above discussion has focused on producing single parts, it will be understood that embodiments of the disclosure embrace processes for forming large numbers of parts simultaneously. FIGS. 7A and 7B demonstrate certain embodiments for producing a plurality of sinter powder manufactured items in accordance with an embodiment. In various embodiments, such processes include fabricating 701 a plurality of sacrificial molds with a fillable space such that an inner volume is defined. In various embodiments, the inner volume forms an internal cavity, internal 3D structure, channel, and/or external geometry of a sinter powder manufactured item. In several embodiments the plurality of sacrificial molds can be stacked to form a sintering assembly with a uniform external geometry. In many embodiments, such processes include (but are not limited to) filling the inner volume of each sacrificial mold with at least one part material 704 before stacking the plurality of sacrificial molds to create a sintering assembly 705. In some embodiments, such processes include (but are not limited to) stacking the plurality of sacrificial molds to create a sintering assembly 702 before filling the inner volume of each sacrificial mold with at least one part material 703. In some embodiments the plurality of sacrificial molds may be configured as stackable shapes, such as a disk or cylinder. In many embodiments the stack of sacrificial molds has at least one fillable to receive at least one part material. In some embodiments each sacrificial mold in the stack has identical an identical inner volume geometry. In several embodiments each sacrificial mold in the stack has a different inner volume geometry. In many embodiments each sacrificial mold in the stack includes (but are not limited to) a registration line, a registration tab, registration bead and dimple, and any combination thereof to align multiple sacrificial molds within a sintering die. To achieve isometric pressure for uniform densification of the part material, the stack of a plurality of filled sacrificial mold that create the sintering assembly has a regular shape such as a cylinder in many embodiments. In many embodiments the mold material may be identical for each stackable sacrificial mold. In several embodiments the part material may be identical for each filled stackable sacrificial mold. At least one mold material has a higher sintering temperature than at least one part material.

As shown in FIG. 1 the process in accordance with some embodiments may further incorporate the use of an optional modeling step prior to manufacture. In some such embodiments, the process includes further steps of modelling a desired sinter powder manufactured component with desired internal and/or external geometry 106 and/or modelling desired component and mold materials to determine sintering parameters 107 prior to manufacture.

A model, in accordance with many embodiments, may be used to predict the evolution and/or distortions of the complex-shaped powder assembly during the sintering process. SPS is a process where three main physical phenomena are involved and interconnected: densification, thermal distribution and electrical behavior of the specimens. SPS involves Joule heating, densification, and field phenomena. In many embodiments, a model simulates the thermal and electrical current distribution and the densification during SPS, Finite Element Method (FEM).

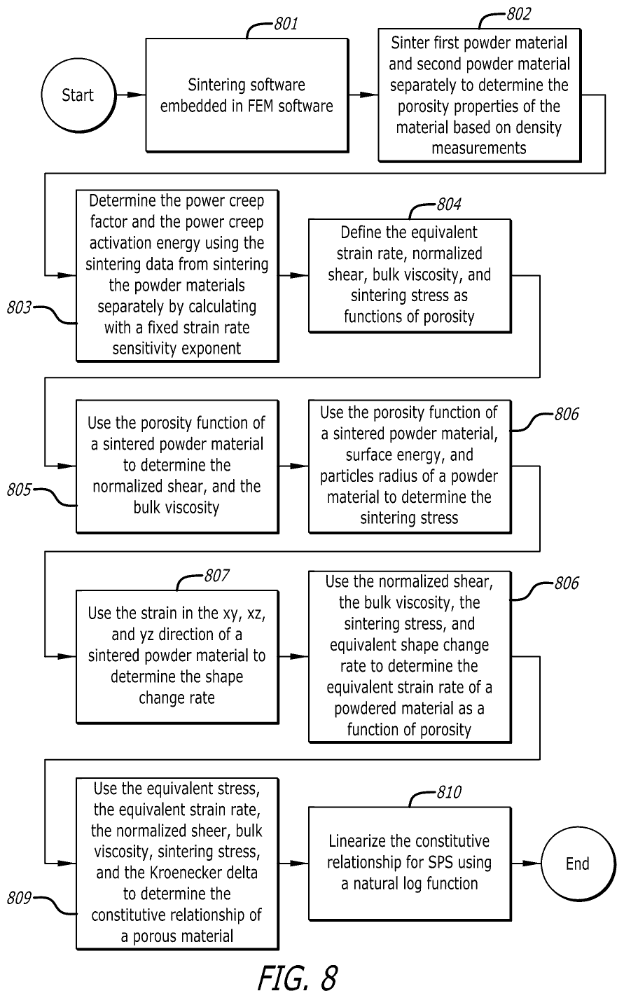

The sintering behavior of the powder assembly is influenced by the contribution of the different powders that compose it. Therefore, the geometry of the components at the end of sintering cannot be predicted using the mass conservation law. The sintering model embedded in an FEM software (COMSOL Multiphysics®) allows the prediction of the densification and displacement that occurs during sintering is a useful tool for the design of the initial geometry of the components. FIG. 8 illustrates the modelling process.

The description of the mechanics of the powder compact is defined using the constitutive relationship 809 of the continuum theory of sintering.

$${σ}_{ij} = \frac{σ ( W )}{W} [ φ {\dot{ε}}_{ij} + ( ψ - \frac{1}{3} φ ) \dot{e} {δ}_{ij} ) ] + {P}_{L} {δ}_{ij} \qquad ( 1 )$$

The stress tensor components are σᵢⱼ (Pa) and σ(W) (Pa) is the effective equivalent stress that determines the constitutive behavior of a porous material. W (s⁻¹) is the equivalent strain rate, \dot{ε}ᵢⱼ(s⁻¹) represents the strain rate tensor components, φ and ψ are, respectively, the normalized shear and bulk viscosities, P_{L} (Pa) is the sintering stress, and δᵢⱼ is the Kroenecker delta. The equivalent stress for the SPS of a powder material is based on the power-law creep Equation 2:

$$σ ( W ) = {AW}^{m} \qquad ( 2 )$$

Where m is the strain rate sensitivity exponent, and A (Pa s^{m}) is the power-law creep coefficient.

$$A = \frac{1}{{A}_{0}^{m}} {T}^{m} exp ( \frac{mQ}{RT} ) \qquad ( 3 )$$

A₀ (K Pa^{-1/m} s⁻¹) is the power creep factor, T (K) is the absolute temperature, R (J mol⁻¹ K⁻¹) is the gas constant, and Q (J mol⁻¹) is the power creep activation energy.

In various embodiments such process conditions are not sufficient to sinter the graphite powder that comprises the sacrificial part, the graphite equivalent stress is based on the conditions of cold compaction where σ_{y} (Pa) is the yield strength:

$$σ ( W ) = {σ}_{y} \qquad ( 4 )$$

Considering a porous material, the equivalent strain rate (Equation 5) 808, normalized shear (Equation 6) 705, bulk viscosity (Equation 7) 805, and sintering stress (Equation 8) 706 are defined as functions of porosity θ 804:

$$W = \sqrt{\frac{φ {\dot{γ}}^{2} + ψ {\dot{e}}^{2}}{1 - θ}} \qquad ( 5 )$$

$$φ = {( 1 - θ )}^{2} \qquad ( 6 )$$

$$ψ = \frac{2}{3} \frac{{( 1 - θ )}^{3}}{θ} \qquad ( 7 )$$

$${P}_{L} = \frac{3 α}{{r}_{0}} {( 1 - θ )}^{2} \qquad ( 8 )$$

where α is the surface energy (J m⁻²), r₀ is the particles radius (μm).

The shape change rate (s⁻¹) 807 is defined as:

$$\dot{γ} = \sqrt{2 ( {\dot{ε}}_{xy}^{2} + {\dot{ε}}_{xz}^{2} + {\dot{ε}}_{yz}^{2} ) + \frac{2}{3} ( {\dot{ε}}_{x}^{2} + {\dot{ε}}_{y}^{2} + {\dot{ε}}_{z}^{2} ) - \frac{2}{3} ( {\dot{ε}}_{x} {\dot{ε}}_{y} + {\dot{ε}}_{x} {\dot{ε}}_{z} + {\dot{ε}}_{y} {\dot{ε}}_{z} )} \qquad ( 9 )$$

In many embodiments such processes to determine the sintering parameters (strain rate sensitivity and power law creep coefficient), the sintering materials (HAP, alumina, stainless steel) are sintered separately. Equation 10 is used to linearize the constitutive equation for the SPS 810:

$$\frac{1}{m} ln ( \frac{\vert {σ}_{z} \vert}{{( ψ + \frac{2}{3} φ )}^{1 + \frac{m - 1}{2}} {( 1 - θ )}^{\frac{1 - m}{2}}} ) - ln ( T ) = - ln ( {A}_{0} ) + \frac{Q}{RT} \qquad ( 10 )$$

In several embodiments the A₀ and Q parameters may be identified through the regression of the experimental data for a fixed m value. In many embodiments the graphite sacrificial mold is considered to be subjected to cold compaction, and in this case the effective equivalent stress is described as:

$$σ ( W ) = {σ}_{y} \qquad ( 11 )$$

Where σ_{y} [MPa] is the yield strength and the creep parameter m˜0.

In some embodiments, to determine the value of σ_{y}, the graphite powder is subjected to multi-step pressure dilatometry.

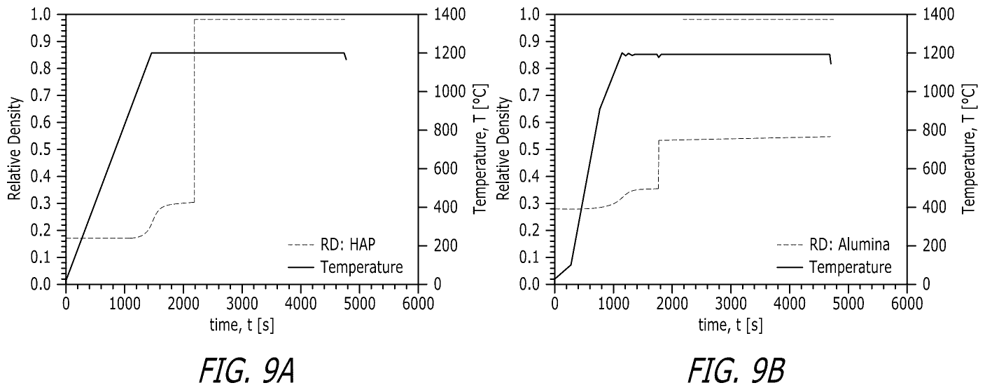

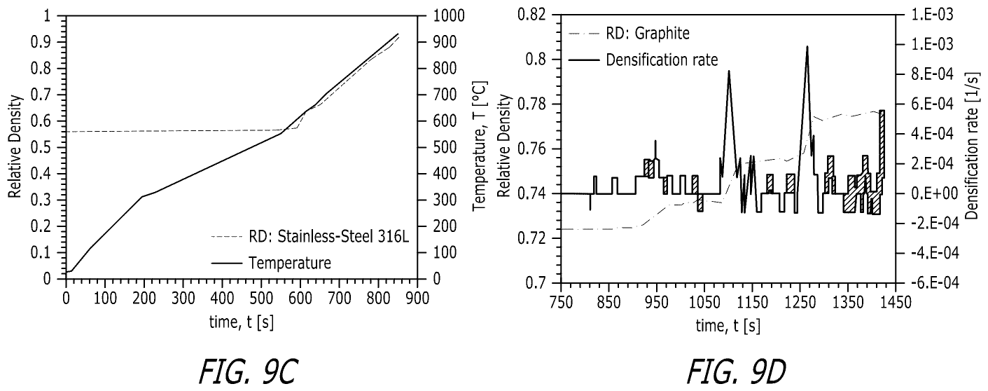

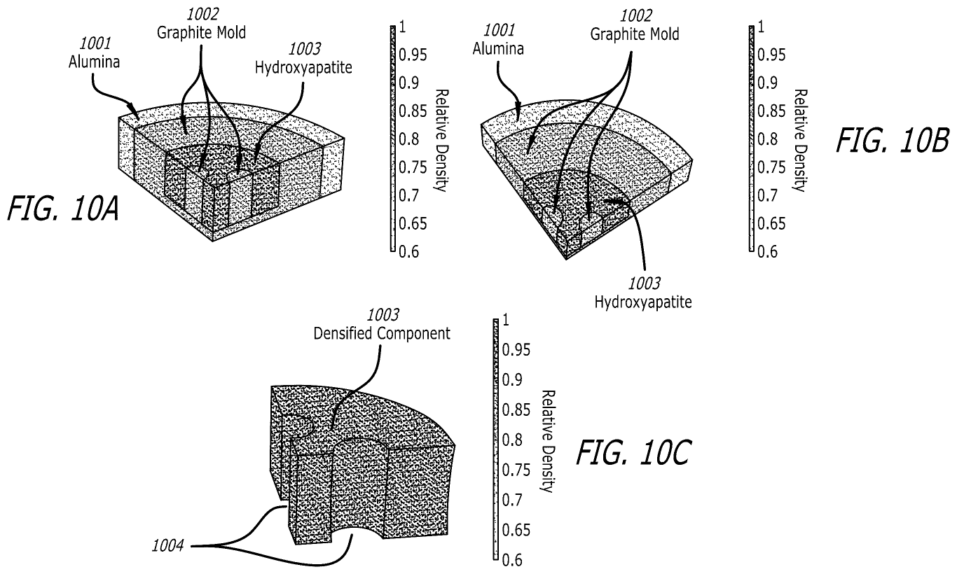

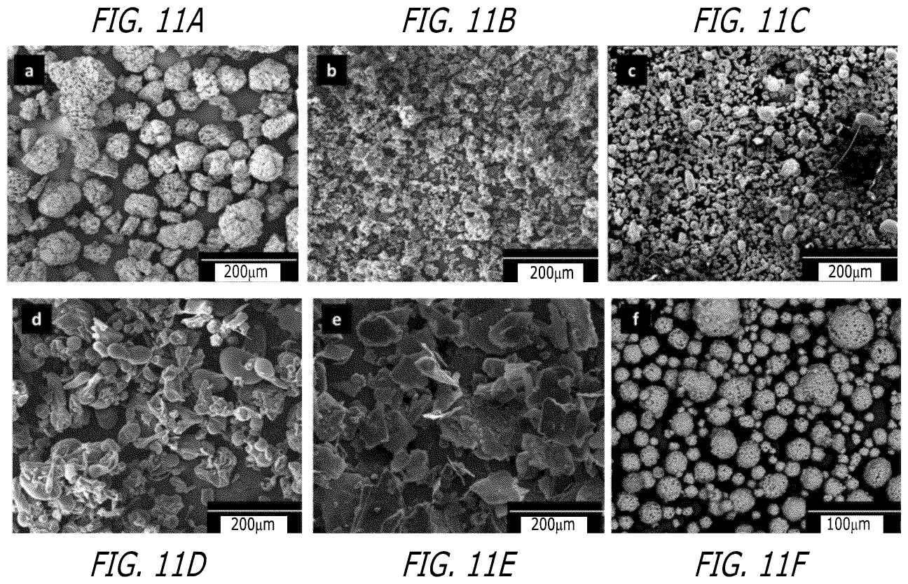

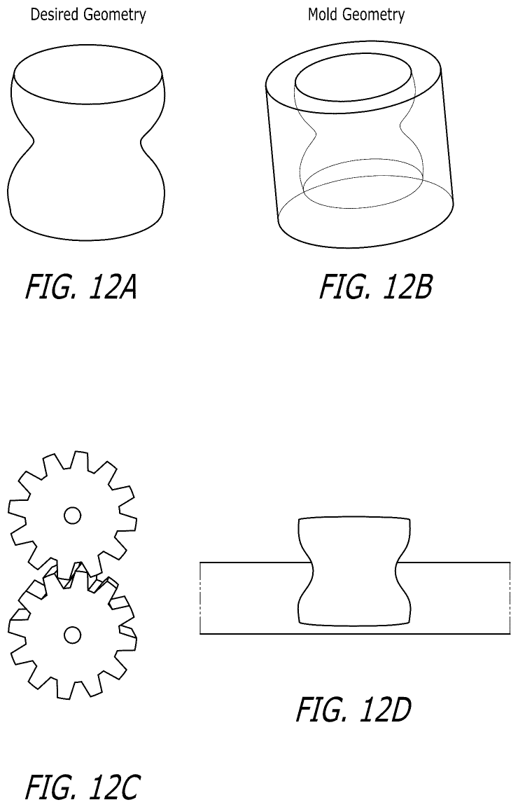

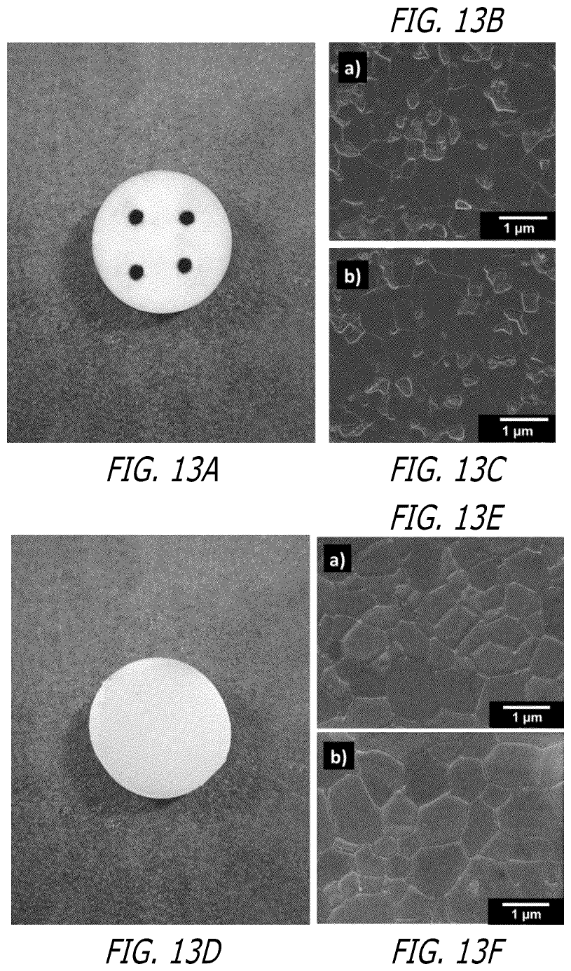

Density measurements of all components in the sintering cycle are input parameters for the finite element model. FIGS. 9A through 9D demonstrate the densification curves during cold compaction (graphite 9D) and sintering (alumina FIG. 9B, HCP FIG. 9A and stainless steel FIG. 9C). FIGS. 10A through 10C illustrate the model's results, in accordance with an exemplary embodiment, for the HAP 4-channel component. It is possible to observe the different densification levels reached by the three materials that compose the initial assembly (graphite 1002, alumina 1001 and HAP 1003). The external ring made from alumina 1001 reached a final relative density of around 70%, meanwhile the graphite mold 1002 was compacted up to 80-85%; therefore, these sacrificial parts are easily removed from the final component which reached full density.

The comparison between the dimensions of the different geometrical features measured in the real and in the “virtual” component show good agreement with only small differences that can be derived from experimental uncertainty. Some of this uncertainty can be derived from the dimensional precision of the printed mold, in accordance with an embodiment which is affected by the resolution of the solvent jetting process.

### EXEMPLARY EMBODIMENTS

Although specific embodiments of systems and apparatuses are discussed in the following sections, it will be understood that these embodiments are provided as exemplary and are not intended to be limiting. Density measurements of all components in the sintering cycle are input parameters for the finite element model. The theoretical densities of the printed powder and mold are determined using a helium gas pycnometer. Relative densities of printed molds and tap densities of the powders are then determined via the geometrical measurement method. The bulk densities of the sintered parts are estimated using the Archimedes' immersion method following ASTM standard C373-18.

Scanning Electron Microscopy is performed on polished and etched surfaces to analyze the microstructure of the material; grain size and porosity are assessed. The ceramic sample is thermally etched at approximately 950° C. for about 30 minutes and the metallic surface is chemically etched.

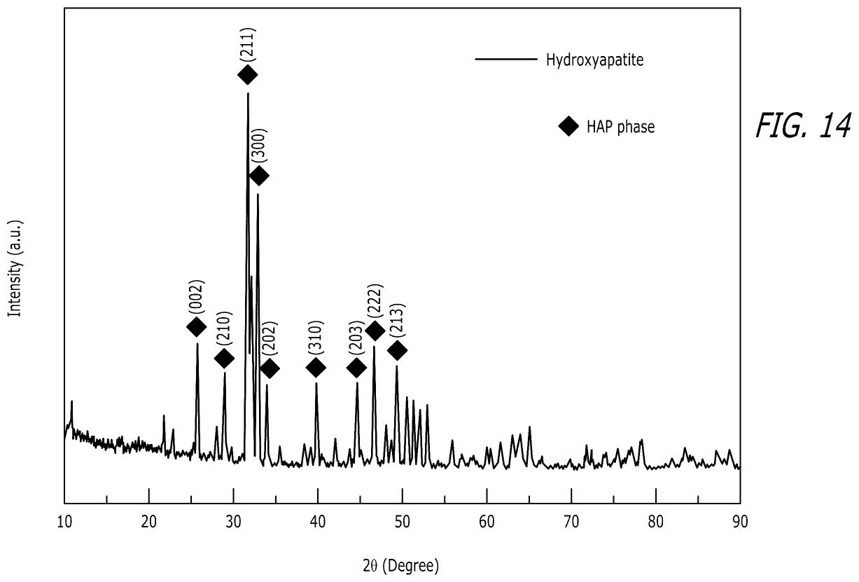

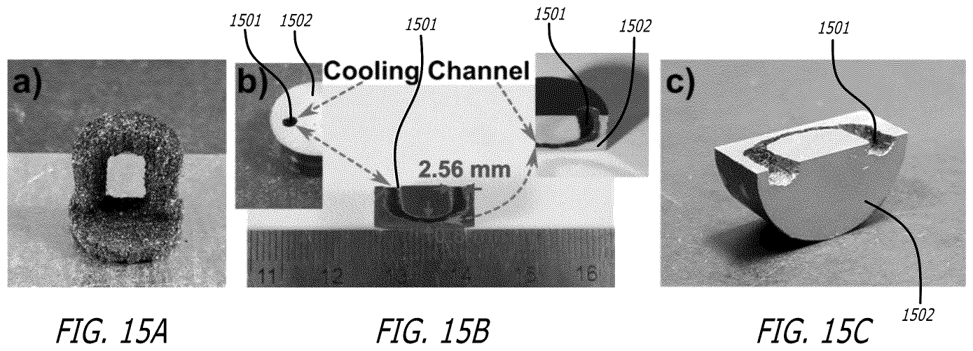

FIGS. 14A through 14D demonstrate the densification curves during cold compaction (graphite 14D) and sintering (alumina FIG. 14B, HCP FIG. 14A and stainless steel FIG. 14C). FIGS. 15A through 15C illustrate the model's results, in accordance with an embodiment, for the HAP 4-channel component. It is possible to observe the different densification levels reached by the three materials that compose the initial assembly (graphite 1502, alumina 1501 and HAP 1503). The external ring made from alumina 1501 reached a final relative density of around 70%, meanwhile the graphite mold 1502 was compacted up to 80-85%; therefore, these sacrificial parts are easily removed from the final component which reached full density.

The comparison between the dimensions of the different geometrical features measured in the real and in the “virtual” component show good agreement with only small differences that can be derived from experimental uncertainty. Some of this uncertainty can be derived from the dimensional precision of the printed mold, in accordance with an embodiment which is affected by the resolution of the solvent jetting process.

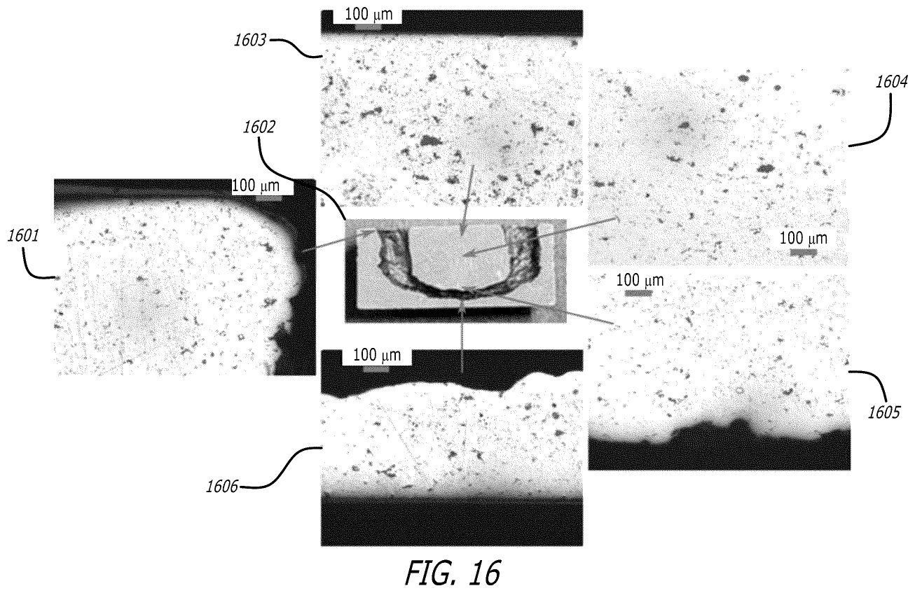

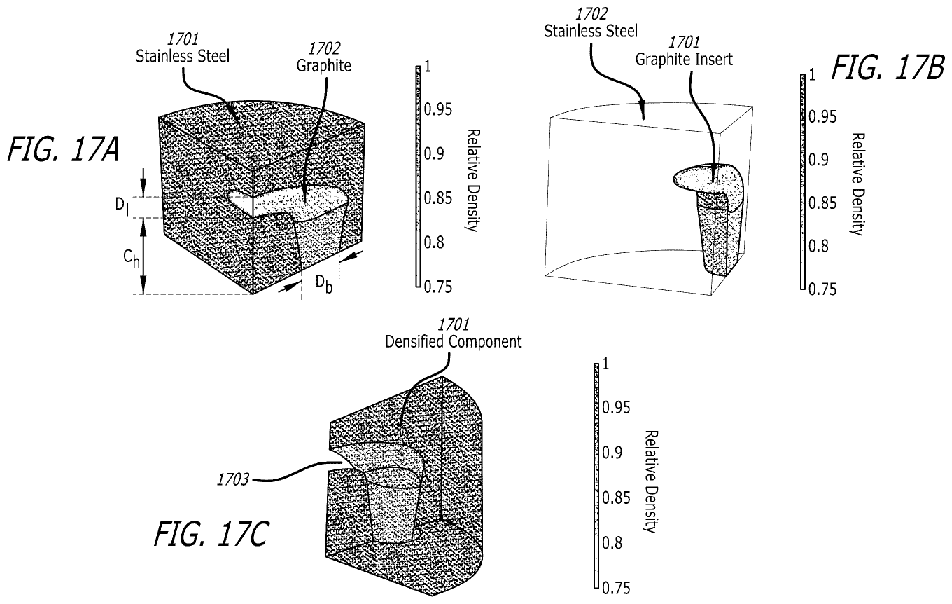

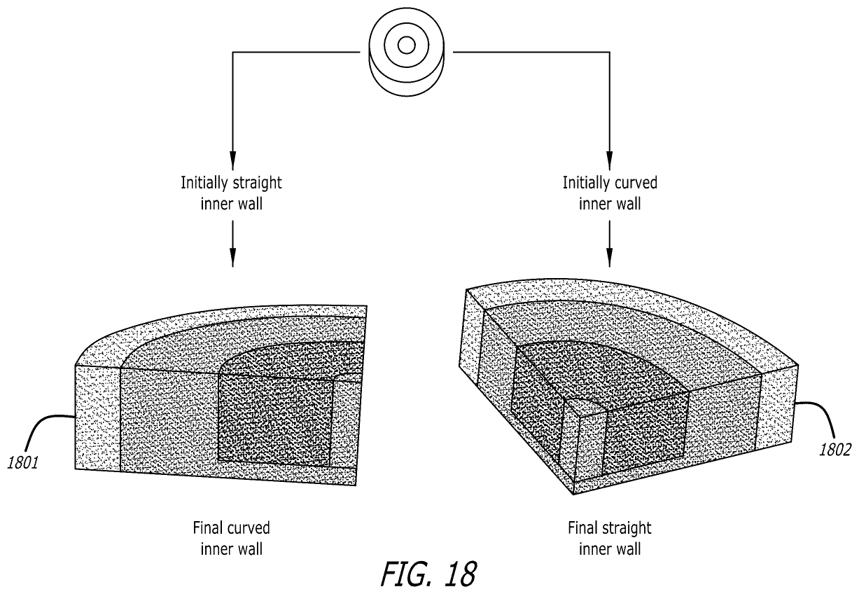

Similarly, the model is run for the stainless steel component with the internal loop channel feature, in accordance with an embodiment. FIGS. 16A through 16C illustrate the model results for the stainless steel component with the internal loop feature in accordance with an embodiment. It is possible to appreciate the ability of the model to predict the varying levels of densification of the different materials used in a process in accordance with an embodiment. For the stainless-steel part 1601, the model, in accordance with an embodiment, predicted a final relative density of 98% which was in agreement with the experimental results. For both the HAP and the stainless-steel components, the model, in accordance with an embodiment, is capable of predicting the final dimension of the internal channel.

### Doctrine of Equivalents

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

1. A process for producing a sintered powder manufactured item, comprising:
providing a sintering die defining a die volume;
providing at least one sacrificial mold body formed of at least one mold material;
disposing the at least one sacrificial mold body in the at least one sintering die to form a sintering assembly having a geometrically uniform external contour defined by the sintering die volume and an inner volume having at least one geometrically inhomogeneous fillable space defined by the at least one sacrificial mold body;
loading the inner volume with at least one part material to form a filled sintering assembly that is geometrically homogeneous, wherein the at least one part material has a lower sintering temperature than the at least one mold material;
sintering the filled sintering assembly at a sintering temperature, such that the at least one mold material remains un-sintered and the at least one part material sinters to form a sintered manufactured item having a shape defined by the inner volume of the sintering assembly.

2. The process of claim 1, further comprising removing the at least one mold material from the sintered manufactured item.

3. The process of claim 2, wherein removing the at least one mold material comprises a process selected from the group consisting of scraping, using compressed air, sand blasting, annealing, and any combination thereof.

4. The process of claim 1, wherein providing the at least one sacrificial mold comprises an additive manufacturing process.

5. The process of claim 4, wherein the additive manufacturing process is selected from the group consisting of binder jetting, solvent jetting, 3D printing, stereolithography, and any combination thereof.

6. The process of claim 1, wherein the at least one mold material comprises at least one binder and at least one material selected from a group consisting of metal powder, a metal alloy powder, a ceramic powder, a polymer powder, a clay powder, a graphite powder, and any combination thereof.

7. The process of claim 1, wherein preparing the at least one sacrificial mold further comprises heating the at least one sacrificial mold such that the at least one mold material undergoes partial debinding.

8. The process of claim 1, wherein the at least one part material comprises at least material selected from the group consisting of a metal powder, a metal alloy powder, a ceramic powder, a polymer powder, a stainless steel powder, a Titanium alloy powder, a Nickel alloy powder, a Chromium alloy powder, an Aluminum alloy powder, and any combination thereof.

9. The process of claim 1, wherein providing the at least one sacrificial mold further comprises coating an external surface of the at least one sacrificial mold with a coating material, such that the coating material acts as an insulator.

10. The process of claim 1, wherein the coating material is alumina.

11. The process of claim 1, for stacking a plurality of sacrificial molds of claim 2 further comprising interleaving a separator between each sacrificial mold, such that cross-linking between a plurality of sinter powder manufactured items is reduced.

12. The process of claim 1, further comprising selecting the at least one part and at least one mold materials using a sintering model embedded in an FEM software based on a continuum theory of sintering comprising:
a sintering data for the part and the mold material;
inputting the sintering data into the sintering model to determine a porosity function for each material;
determining a power creep factor and a power creep activation energy based on the sintering data for each material using a strain rate sensitivity exponent that is fixed;
defining an equivalent strain rate, a normalized shear, a bulk viscosity, and a sintering stress as the porosity function for each material; and
determining at least one parameter selected from the group of
a normalized shear and a bulk viscosity using the sintering data for each of the part and mold material,
a sintering stress based on at least one of a surface energy, a powder particle radius, and the sintering data of each of the part and mold material,
a shape change rate based on the sintering data for each of the part and mold material,
an equivalent strain rate based on at least one of the bulk viscosity, the sintering stress, the shape change rate, and the sintering data of each of the part and mold material, and
a constitutive relationship of each of the part and mold material based on the equivalent stress, the equivalent strain rate, the normalized sheer, the bulk viscosity, the sintering stress, and a Kroenecker delta.

13. The process of claim 12, further comprising linearizing the constitutive relationship of each of the part and mold material for SPS using a natural log function.

14. The process of claim 1, wherein sintering comprises spark plasma sintering.

15. The process of claim 1, wherein the sintering is conducted in a vacuum.

16. The process of claim 1, wherein the sintering is conducted in an atmosphere of an inert gas selected from the group consisting of Nitrogen, Argon, and Helium.

17. The process of claim 1, wherein the sintering is conducted at a pressure of from about 1 to 10 Torr.

18. The process of claim 1, wherein the sintering is conducted at a temperature of from about 1000° C. to 1900° C.

19. The process of claim 1, wherein the sintering is conducted at a temperature of from about 500° C. to 1200° C.

20. The process of claim 1, further comprising cleaning the sinter powder manufactured item.

21. The process of claim 1, wherein the cleaning is selected from a process selected from the group of compressed air, polishing, annealing, and any combination thereof.

22. The process of claim 1, wherein the at least one sacrificial mold defines an internal structure of the sinter powder manufactured item selected from the group consisting of an internal cavity, a channel, an internal 3D structure, and any combination thereof.

23. The process of claim 1, wherein the at least one sacrificial mold defines a geometrically irregular external surface of the sinter powder manufactured item.

24. The process of claim 1, wherein the at least one sacrificial mold defines an internal structure of the sinter powder manufactured item selected from the group consisting of an internal cavity, a channel, an internal 3D structure, and any combination thereof, and a geometrically irregular external surface of the sinter powder manufactured item.

25. The process of claim 1, further comprising:
forming a plurality of sintering assemblies;
stacking the plurality of filled sintering assemblies to form a stack of filled sintering assemblies that is geometrically homogeneous; and
sintering the stack of filled sintering assemblies to simultaneously form a plurality of sintered manufactured items.

26. The process of claim 25, further comprising interleaving a separator layer between each of the plurality of sintering assemblies, such that cross-linking between a plurality of sinter powder manufactured items is reduced.

27. The process of claim 26, wherein the separator layer is formed of graphite foil.

28. The process of claim 25, wherein each of the sintering assemblies further comprises an alignment element selected from the group consisting of a registration line, registration tab, a registration bead and dimple, and any combination thereof.

29. The process of claim 1, comprising a plurality of separate sacrificial molds each formed of at least one mold material that is the same or different.

30. The process of claim 1, comprising a plurality of fillable spaces each separately loaded with at least one part material that is the same or different.

31. An apparatus for producing a sintered powder manufactured item, comprising:
a sintering chamber configured to apply a sintering pressure and a sintering temperature;
a sintering die defining a die volume disposed within the sintering chamber;
at least one sacrificial mold body formed of at least one mold material, and configured to be disposed in the at least one sintering die to form a sintering assembly having a geometrically uniform external contour defined by the sintering die volume and an inner volume having at least one geometrically inhomogeneous fillable space defined by the at least one sacrificial mold body;
wherein the inner volume is configures to be loaded with at least one part material such that a filled sintering assembly may be formed that is geometrically homogeneous, wherein the at least one part material has a lower sintering temperature than the at least one mold material; and
wherein the sintering chamber is configured to sinter the filled sintering assembly at a sintering temperature, such that the at least one mold material remains un-sintered and the at least one part material sinters to form a sintered manufactured item having a shape defined by the inner volume of the sintering assembly.
